(19) United States
(12) Patent Application Publication
(10) Pub. No.: US 2015/0322919 A1
(43) Pub. Date: Nov. 12, 2015

(54) Electricity Generating Wind Turbine

(71) Applicant: Carlos Alberto Acosta-Nassar, San Rafael de Alajuela (CR)

(72) Inventor: Carlos Alberto Acosta-Nassar, San Rafael de Alajuela (CR)

(73) Assignee: Corporación SkyTwister S. A., San Rafael de Alajuela (CR)

(21) Appl. No.: 14/705,963

(22) Filed: May 6, 2015

Related U.S. Application Data
(60) Provisional application No. 61/989,465, filed on May 6, 2014.

(51) Int. Cl. F03D 1/06; F03D 9/00; F03D 11/00; F03D 7/02

(52) U.S. Cl. CPC F03D 1/0683; F03D 1/0691; F03D 7/0204; F03D 9/002; F03D 11/0058

(57) ABSTRACT

The invention relates to a wind turbine rotor comprising of a central warhead, blades with asymmetrical conical geometry and an external girth. The warhead distributes air from to a central section aerodynamically to the blades, which together account for more area than an area of a circle described by an outer girth or cinch around all said blades, so they produce more torque than conventional turbines. The outer girth eliminates friction between the blades and the wind and also stiffens the whole rotor. There is also a stiffening polygon between the blades. Being a multi-blade turbine together with the geometrical form of the blades makes the turbine starts generating at 3 to 4 m/s wind speed. The present invention is good looking and silent.

The current application claims a priority to the U.S. Provisional Patent application Ser. No. 61/989,465 filed on May 6, 2014.

### FIELD OF THE INVENTION

The present invention relates generally to an apparatus for an electricity generator. More specifically, the present invention is an electricity generator wind mill with turbine rotors that creates efficient energy from wind.

### BACKGROUND OF THE INVENTION

Wind turbines are classified into two main classes: those in which air flow goes perpendicular to an axis of a turbine and those in which air flows parallel to the axis. Among those with flow perpendicular to the axis, most of them has vertical axis although there are also with horizontal shafts. Those with flow parallel to the axis has mainly horizontal axis since air flows in that direction. However, in some cases, if the air comes through a pipeline, the turbine can be installed with its axis vertically.

The field of interest of the present invention is that of wind turbines with air flowing parallel to the axis. Within this field are distinguished propeller type turbines and windmill type among others.

Propeller type turbines operate at relatively high speed, low torque and have few blades, typically six or less and mostly only two or three. In addition, these blades are typically airplane wing-shaped profile and leave a significant open area between them facing the wind. In many cases, the blades of the turbine comprise a pivot device to change its angle with respect to the wind direction. These kinds of turbines produce a lot of noise.

Compared with the propeller type, windmill type turbines operate at relatively less rotation speeds. As they have a higher number of blades, they produce higher torque. Although these blades can also take the form of airplane wing, they tend to be thinner, and most are built from sheets. They have flat form, single or double curvature bending. It is also common that the blades in the rotor remain fixed, although there are versions with adjustable position blade.

In generation of electricity with small turbines, it is feasible using both propeller type turbines and the windmill type. In this range of generation, windmill-type turbines have the advantage because, by generating more torque and operate at lower speeds, they are able to generate at lower-speed winds, while the propeller type turbines usually will stop. This in turn allows a user to place the turbines at lower altitudes, with consequent savings in infrastructure, or in sites that are not particularly favorable for higher wind speed availability. In addition, by operating at lower speeds, the windmills produce less noise.

### BRIEF DESCRIPTION OF THE PRIOR ART

The windmill and propeller type turbines date back several centuries. Here we review some of the patents related to them.

U.S. Pat. No. 237,467, from 1881, shows a basic shape of a windmill with its central hub in a form of a circular plate, a plurality of blades, and a peripheral ring. It incorporates a rear vane to align the shaft with the wind. In this case, a transmission is vertical reciprocating (up and down), which is particularly appropriate for windmills because of their low speed.

U.S. Pat. No. 457,168, from 1891, reflects the use of one or more reinforcing rings and also the implementation of blades formed from thin sheets with curves.

U.S. Pat. No. 1,467,227, from 1921, shows that not only blades are formed from curved surfaces or angle changes between its input and output, but also have curved edges, so that these blades are extended to form a slight spiral.

U.S. Pat. No. 2,417,022, from 1945, shows the use of conical gears to transmit power in the form of rotary motion through a transmission shaft. This extends the scope of application of the turbines and makes them suitable, for example, to drive an electric generator located near the base of the tower.

U.S. Pat No. 4,086,498, from 1978, and U.S. Pat. No. 4,140,433, from 1979, show a type of turbine that while the design retains vestiges of the type windmill, is designed specifically for generating electricity. In addition, the rotor of the turbine and static parts show the use of conical surfaces, or approximately conical, to guide wind to the blades and to prevent centrifugal flow escaping from the periphery of the rotor.

U.S. Pat. No. 5,910,688, from 1999, continues to search for curved blades from thin sheets. In this case, a helical blade, which not only has a curved surface, but its edges are curved and an angle of entry and exit vary depending on the distance to the center of the rotor.

While in the field of propeller type wind turbines there have been great strides in terms of their aerodynamic shape, as shown in the patents cited, it is not the case in the turbines of the windmill type.

It is therefore an object of the present invention to introduce a turbine rotor of the windmill type, whose blades can be manufactured from sheets, and with a form that allows the use of wind energy as efficiently as possible.

### BRIEF SUMMARY OF THE INVENTION

The present invention provides a wind turbine rotor of a type whose axis is substantially aligned with a direction of the wind. This comprises a warhead rotor connected to a central axis, from which a plurality of blades is attached. It also has a peripheral ring around the ends of said blades and reinforcing polygon crosses all blades at about half of its radial extension.

A main feature of this rotor is that their blades have a conic surface which implies that a total area of all blades is greater than an area of a circle they form. Thus more energy is extracted from the air.

Geometrical surface of each blade is obtained from an imaginary conic surface by cutting a steel sheet in such a way that an edge where winds enters is perpendicular to any line drawn from an apex of the conic surface, while the edge of outgoing wind form an angle with respect to a line drawn from the apex of the conic surface. In this way, the blades get more area near to a cinch than next to a central block. So, the rotor produces more torque than conventional ones.

### BRIEF DESCRIPTION OF THE DRAWING

The drawings illustrate the best mode for carrying out the invention as well as several other examples of possible embodiments of the invention.

FIG. 1 is a left-side illustration of a typical horizontal axis turbine aligned with the direction of the wind, showing its main components and a possible embodiment of the rotor of the present invention.

FIG. 2 is a front perspective illustration of a typical turbine with horizontal axis aligned with the direction of the wind, mainly showing one possible embodiment of the rotor of the present invention.

FIG. 3 is a front perspective illustration of a rotor of the possible embodiment of the present invention.

FIG. 4 is a front perspective illustration of a generation of a conical surface and how it is cut to obtain a shape of the rotor blade possible embodiments of the present invention.

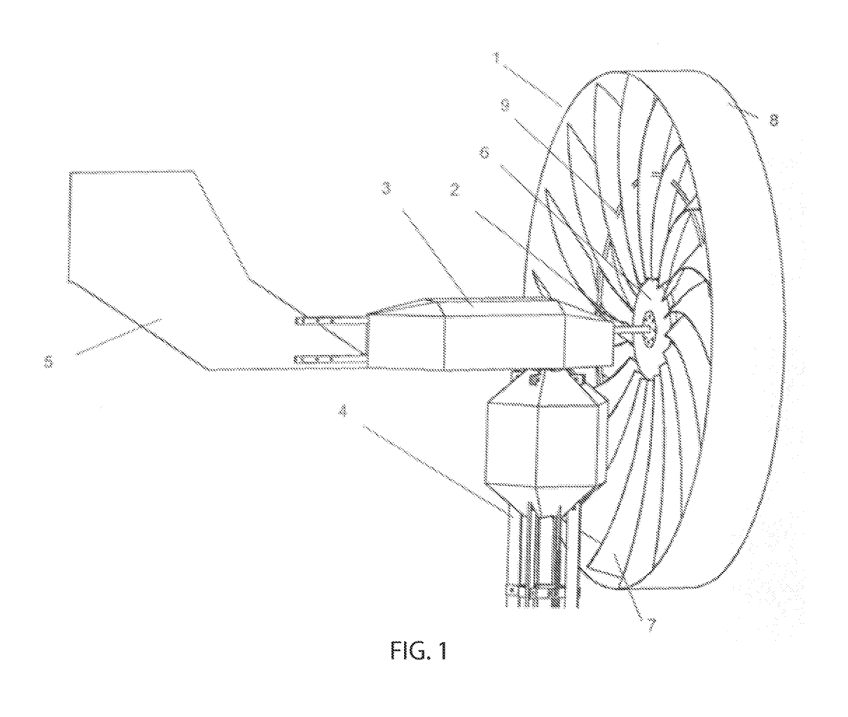

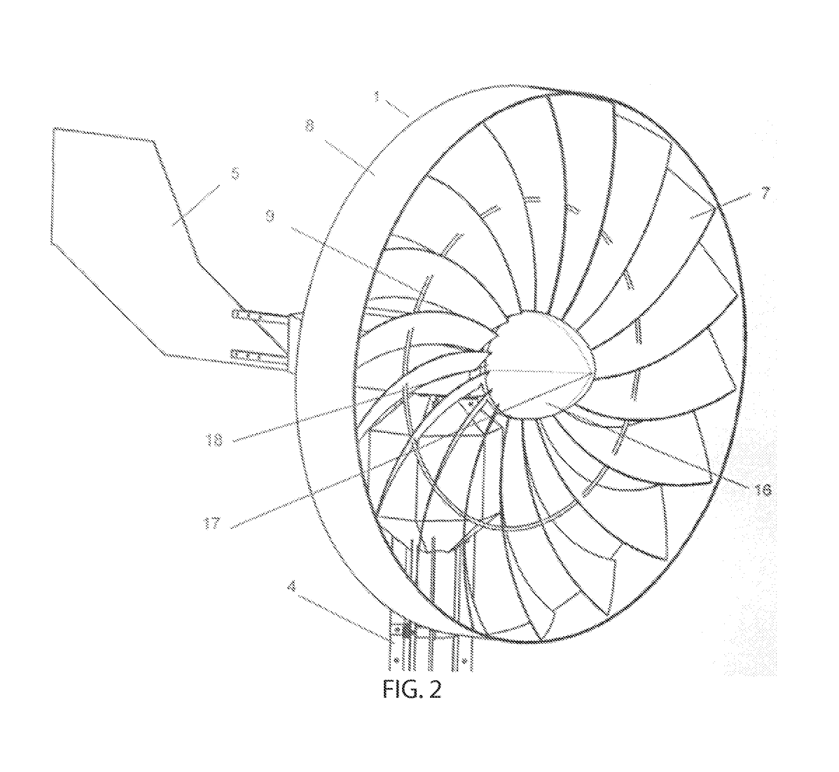

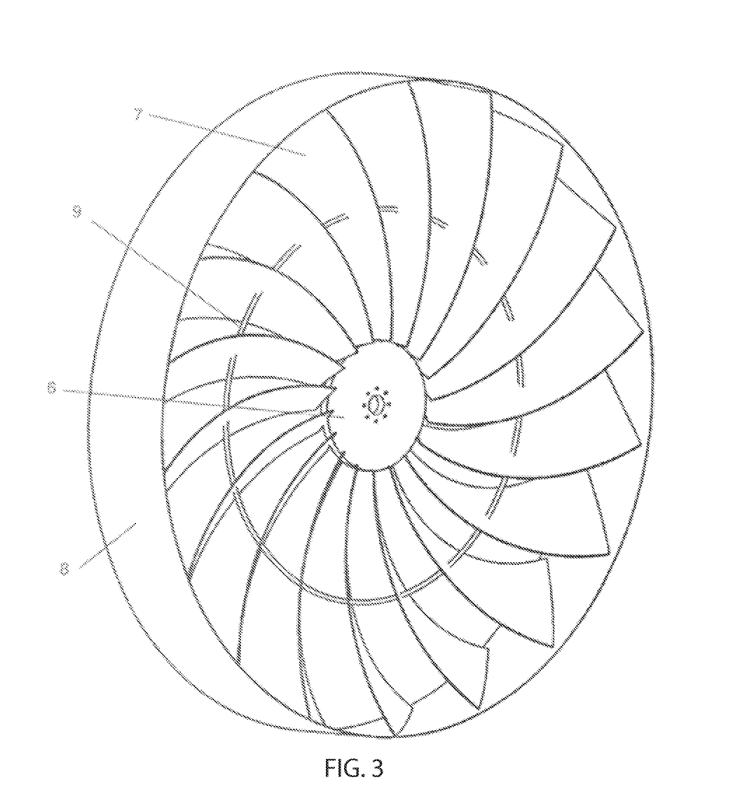

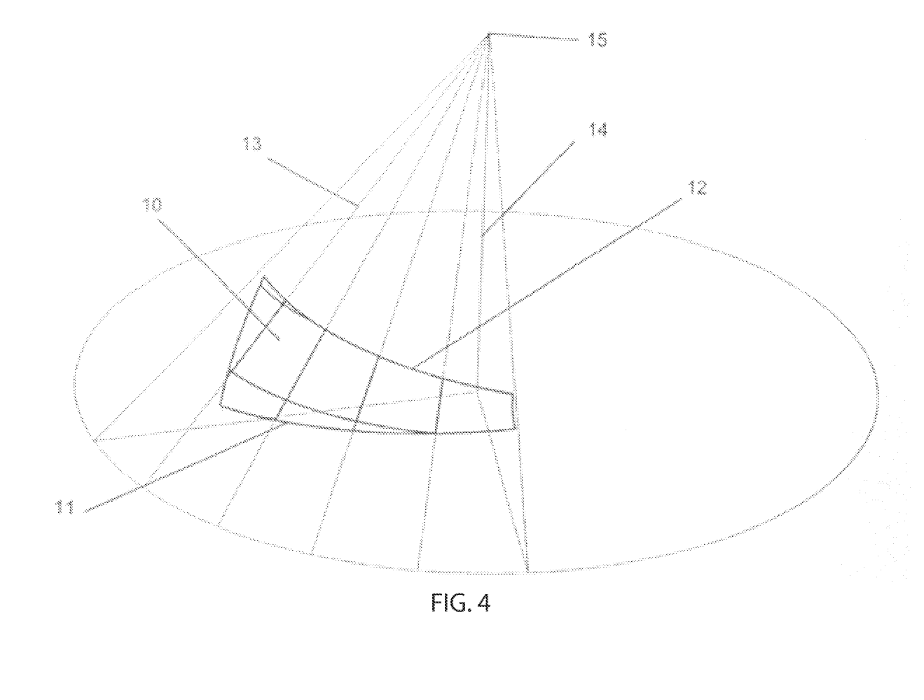

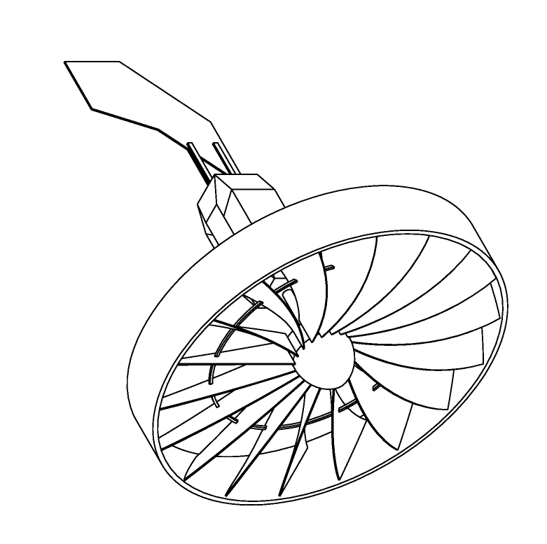

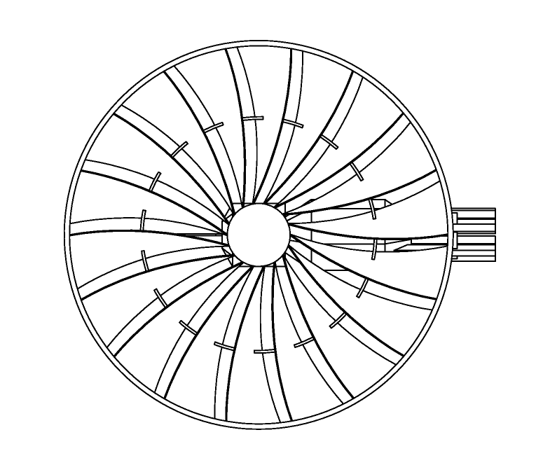

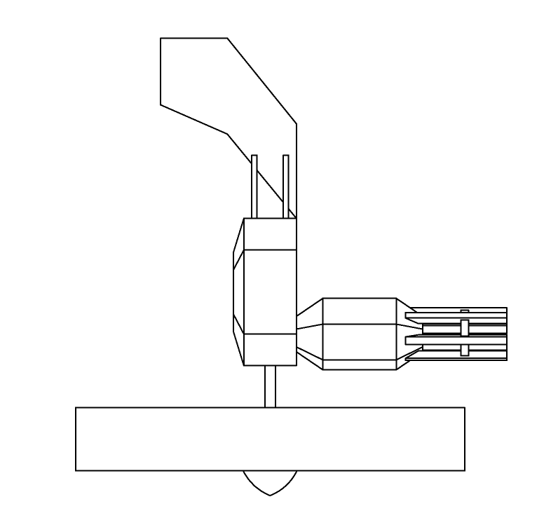

### DETAIL DESCRIPTIONS OF THE INVENTION

All illustrations of the drawings are for the purpose of describing selected versions of the present invention and are not intended to limit the scope of the present invention.

The present invention is an electricity generating windmill by efficiently capturing wind energy through a high torque, low speed turbine rotor. Thus, the present invention comprises a rotor assembly and an energy conversion mechanism. The rotor assembly allows the present invention to convert the linear kinetic energy of the wind into rotational kinetic energy. The rotor assembly functions mainly under the Newton's third law of motion: action-reaction (transfer of momentum). The rotation of the rotor assembly does not correspond to the aerodynamic sustentation principle, so the rotor assembly is noiseless. The energy conversion mechanism is used to further convert the rotational kinetic energy into electrical energy or into another kind of usable energy. In the preferred embodiment of the present invention, the energy conversion mechanism comprises a gearbox and an electrical generator. The gearbox is used to increase the speed of the rotational motion received from the rotor assembly because the rotor assembly for the present invention is designed to work at high torque but at low speeds. As such, the gearbox increases the speed of the rotational motion received from the rotor assembly to the speed required by the electrical generator to properly convert the rotational kinetic energy into electrical energy.

The rotor assembly is oriented about a horizontal rotation axis, which orients the rotor assembly in the direction of incoming winds. The rotor assembly comprises a central hub, a plurality of high-torque producing blades, and an outer annular brace. The central hub provides the rotor assembly with a base to connect the other components of the rotor assembly together. The central hub is positioned along the horizontal rotation axis so that the central hub and the components symmetrically connected about the central hub are able to rotate about the horizontal a rotation axis. The plurality of high-torque producing blades is used to receive the force applied on the present invention by the wind. The plurality of high-torque producing blades is radially connected about the central hub so that the central hub rotates as the wind applies force on the plurality of high-torque producing blades. In the preferred embodiment of the present invention, the plurality of high-torque producing blades forms a slight spiral configuration about the central hub. In order to generate a large amount of torque on the central hub, the number of high-torque producing blades needs to be large enough so that the total surface area that is receiving the wind for the plurality of high-torque producing blades is larger than the circular area that is circumferential delineated the outer annular brace. The outer annular brace is concentrically positioned about the central hub and is peripherally connected to the plurality of high-torque producing blades, which prevents the rotor assembly from producing vortices and from creating noise. The outer annular brace also prevents energy leakage from of centrifugal flow. In addition, the energy conversion mechanism is axially connected to the central hub so that the central hub is able to rotationally drive the energy conversion mechanism. Also in the preferred embodiment, a shaft is used to axially connect the central hub to the energy conversion mechanism.

In order for the wind to apply the most amount of force on the rotor assembly, each of the plurality of high-torque producing blades is shaped as a section of a conical surface. To describe the boundaries of the section of the conical surface, each of the plurality of high-torque producing blades needs to comprise a leading edge, a trailing edge, an outer edge, and an inner edge. The leading edge initiates contact with the wind for each blade, and the trailing edge is the last portion of each blade to make contact with the wind. The leading edge bounds the section of the conical surface in such a way that the leading edge is shaped as a circular arc. Moreover, the leading edge is oriented perpendicular to any straight line drawn from the apex of the conical surface. Similarly, the trailing edge bounds the section of the conical surface, opposite to the leading edge, in such a way that the trailing edge is an elliptical arc. Furthermore, the trailing edge is oriented at an angle with the generatrix of the conical surface. The outer edge and the inner edge bound opposite sides of the section of the conical surface and are positioned in between the leading edge and the trailing edge. Thus, the outer edge is connected adjacent to the outer annular brace, and the inner edge is connected adjacent to the central hub. The shape that is defined by the edges of each blade allows the rotor assembly to convert linear kinetic energy of the wind into rotational kinetic energy at 55% efficiency, which is very close to the Betz limit.

A wind flux plane is a reference geometry to define the arrangement of certain components within the present invention. The wind flux plane is defined by the flow direction of the wind, which is normal to the wind flux plane. The horizontal rotation axis is parallel to the flow direction of the wind, and, thus, the horizontal rotation axis is normal to the wind flux plane. One arrangement defined by the wind flux plane is that the leading edge for each of the plurality of high-torque producing blades is positioned coincident with the wind flux plane. This allows each of the plurality of high-torque producing blades to cut into the wind at the same time. Consequently, the configuration of the plurality of high-torque producing blade allows for the possibility of varying the angle of attacking the wind and the angle for releasing the wind and allows for the possibility of controlling the flow of the wind through the rotor assembly so that the rotor assembly experiences minimum turbulence while capturing the maximum amount of energy from the wind. The configuration of the plurality of high-torque producing blade also allows the rotor assembly to brake itself when the torque produced by the wind equalizes that produced by friction.

An inner annular brace is used to increase the rigidity of the rotor assembly. The inner annular brace is concentrically positioned around the central hub and is integrated through each of the plurality of high-torque producing blades, which allow the inner annular brace to stabilize the middle portion of each blade. In the preferred embodiment of the present invention, the inner annular brace is radially positioned half-way between the central hub and the outer annular brace. Also in the preferred embodiment, the outer annular brace has a hollow cylinder shape in order to connect along the entire outer edge of each blade.

An aerodynamic nose cone allows the rotor assembly to gradually route the wind travelling towards the central hub into the plurality of high-torque producing blades. More specifically, the aerodynamic nose cone comprises an apex and a base, and the horizontal rotation axis centrally traverses through the base to the apex. Thus, as the apex cuts into the wind travelling towards the central hub, the base is connected adjacent to the central hub, opposite to the housing of the energy conversion mechanism.

A wind vane is used to change the orientation of the rotor assembly so that the horizontal rotation axis remain parallel to the flow direction of the wind. Thus, the wind van is positioned adjacent to the housing of energy converting mechanism, opposite to the rotor assembly, so that the wind interacts with the wind vane as the last component before flowing past the present invention. Moreover, the wind vane is positioned perpendicular to the wind flux plane, which aligns the rotor assembly into the flow direction of the wind.

A tower is used to structurally mount the other components of the present invention above the ground. In the preferred embodiment of the present invention, the housing of the energy conversion mechanism is pivotably mounted onto the tower about a vertical rotation axis, which is position parallel to the wind flux plane. This allows the rotor assembly and the energy conversion mechanism to rotate and orient into the direction of the wind.

In some embodiments of the present invention, the location of the rotor assembly in a turbine configuration is alternatively behind the housing for the energy conversion mechanism. In this embodiment, the wind vane is no longer needed for the present invention, but the operation and durability of the rotor assembly can be affected by turbulence generated around the housing and the tower. In other embodiments, the rotor assembly is installed in a fixed frame on a rooftop of a building or to build a set of several small turbines forming a wall.

In some embodiments, the energy conversion mechanism hosts a variety of components such as pulleys that transmit the mechanical energy through to the belts to the generator or generators (depending on the respective size of the rotor assembly) located within its housing. the energy conversion mechanism could also accommodate different electrical and mechanical components typical of wind turbines like centrifugal brakes.

This description does not exclude the possibility of variations in the design to maintain the basic spirit of the present invention, such as a smaller outer annular brace or blades that extend beyond the outer annular brace, variations in the orientation and curvature of the blades, reduction or elimination of inner annular brace, or a different kind of central hub.

### Alternate Detail Description

The present invention is an electricity generator wind mill with turbine rotors that creates efficient energy from wind. The area of application of the present invention is the wind turbine rotors with axis substantially aligned with the wind direction. In a preferred embodiment, a rotor (1) is coupled to a shaft (2) that connects to the rest of the components in a central body (3). Said central body (3) pivots on a tower (4) in order to keep the shaft (2) aligned with the direction of the wind. In order to align the axis with the direction of the wind turbine it has a tail (5) attached to the central body (3) in the location opposite to the rotor (1).

This does not exclude the possibility of locating the rotor in a turbine configuration differently, for example, behind the main body. In this case the tail is no longer needed, but the operation and durability of the rotor can be affected by turbulence generated around the central body (3) and tower (4). Another possibility is to install the rotor in a fixed frame on a rooftop of a building or to build a set of several small turbines forming a wall.

The central body (3) hosts a variety of components such as pulleys that transmit the mechanical energy through to the belts to the generator or generators (depending on the respective size of the rotor) located within said body. It could also accommodate different electrical and mechanical components typical of wind turbines like centrifugal brakes.

In the preferred configuration of the rotor (1), it comprises of a central block (6) directly coupled to the shaft (3), a set of blades (7), a peripheral ring (8) and a reinforcing ring (9), all securely linked together.

The central block (6) extends radially in a circular plate with a diameter and thickness large enough to provide sufficient area for the attachment of the blades (7). This does not exclude the possibility of using a different block, provided it is suitable for blades installation.

The blades (7) extend radially from the central block (6) forming a slight spiral. These blades come from a conical surface (10) cut so that the edge where the wind enters (11) is perpendicular to any straight line drawn from the apex of the conical surface, while the edge where the wind exits (12) forms an angle with respect to said line called generatrix (13) of the said conic surface (10).

This form of blade enables the possibility of varying the angle of attack and angle of the exit wind, and also the possibility of control wind flow through the rotor so that there is a minimum of turbulence and capture as much energy as possible.

In a preferred embodiment, the peripheral ring (8) is cylindrical with its axis coincident with the axis (2) and surrounds the turbine blades (7) extending axially to cover the axial extension of said blades (7). This peripheral ring (8) has three functions: it provides rigidity to the rotor assembly eliminates leaks by turbulence at the tips of the blades (7) and prevents energy leakage in the form of centrifugal flow. The reinforcement ring (9) is fixedly attached to all the blades (7) about half the radial extent and provides additional rigidity.

Finally, in the preferred configuration, a warhead of aerodynamic shape (16) is fixed to the central block (6). The axis of the warhead (16) coincides with the axis of the turbine (2), the vertex (17) points towards the wind and its base (18) covers the central block (6). This warhead (16) receives the flow of air that would otherwise crash into the central block (6) and gently directs it to the blades (7).

This description does not exclude the possibility of variations in the design to maintain the basic spirit of the invention, such as a peripheral smaller ring (8), or blades (7) which extend beyond the ring (8), variations in the orientation and curvature of the blades (7), reduction or elimination of reinforcement ring (9), or a different central block (6).

Although the invention has been explained in relation to its preferred embodiment, it is to be understood that many other possible modifications and variations can be made without departing from the spirit and scope of the invention as herein described.

What is claimed is:

1. An electricity generating windmill comprises:
a rotor assembly;
an energy conversion mechanism;
said rotor assembly comprises a central hub, a plurality of high-torque producing blades, and an outer annular brace;
said central hub being positioned along a horizontal rotation axis;
said horizontal rotation axis being positioned normal to a wind flux plane;
said plurality of high-torque producing blades being radially connected about said central hub;
said outer annular brace being concentrically positioned around said central hub;
said outer annular brace being peripherally connected to said plurality of high-torque producing blades;
said energy conversion mechanism being axially connected to said central hub, wherein the central hub rotationally drives the energy conversion mechanism;

2. The electricity generating windmill as claimed in claim 1 comprises:
each of said plurality of high-torque producing blades being shaped as a section of a conical surface;
each of said plurality of high-torque producing blades comprises a leading edge and a trailing edge;
said leading edge bounding said section of said conical surface;
said leading edge being shaped as a circular arc;
said trailing edge bounding said section of said conical surface, opposite to said leading edge;
said trailing edge being shaped as an elliptical arc;

3. The electricity generating windmill as claimed in claim 2 comprises:
each of said plurality of high-torque producing blades further comprises an outer edge and an inner edge;
said inner edge bounding said section of said conical surface;
said inner edge being connected adjacent to said central hub;
said outer edge bounding said section of said conical surface, opposite to said inner edge;
said outer edge being connected adjacent to said outer annular brace;

4. The electricity generating windmill as claimed in claim 2 comprises:
said leading edge for each of said plurality of high-torque producing blades being positioned coincident with said wind flux plane;

5. The electricity generating windmill as claimed in claim 1 comprises:
an inner annular brace;
said inner annular brace being concentrically positioned around said central hub;
said inner annular brace being integrated through each of said plurality of high-torque producing blades;
said inner annular brace being radially positioned in between said central hub and the outer annular brace;

6. The electricity generating windmill as claimed in claim 1 comprises:
an aerodynamic nose cone;
the aerodynamic nose cone comprises an apex and a base;
the horizontal rotation axis centrally traversing through the base to the apex;
the base being connected adjacent to the central hub;

7. The electricity generating windmill as claimed in claim 1 comprises:
a wind vane;
the wind vane being positioned adjacent to a housing of the energy converting mechanism, opposite to the rotor assembly;
the wind vane being positioned perpendicular to the wind flux plane;

8. The electricity generating windmill as claimed in claim 1 comprises:
a tower;
a housing of the energy converting mechanism being pivotably mounted onto the tower about a vertical rotation axis;
the vertical rotation axis being positioned parallel to the wind flux plane;
